(19) United States
(12) Patent Application Publication
(10) Pub. No.: US 2012/0243453 A1
(43) Pub. Date: Sep. 27, 2012

(54) Apparatus and Method for Configuring a Transmission Capability of a Mobile Communication System onto Unused Radio Bands/Channels

(75) Inventors: Sami-Jukka HAKOLA, Kempele (FI); Samuli Turtinen, Li (FI); Timo Koskela, Oulu (FI)

(73) Assignee: Renesas Mobile Corporation

(21) Appl. No.: 13/052,416

(22) Filed: Mar. 21, 2011

(51) Int. Cl. H04W 72/04; H04W 52/02

(52) U.S. Cl. 370/311; 370/329

(57) ABSTRACT

An apparatus, method and computer program product determine channels of a television radio-band which are free of signal transmission and channels with active signal transmission, select a group of channels immediately adjacent in the frequency domain among the channels which are free of signal transmission, allocate a downlink bandwidth to channels of the selected channel group which are not immediately adjacent in the frequency domain to a channel with active signal transmission, and allocate an uplink bandwidth to all channels of the selected channel group.

### TECHNICAL FIELD

The present application relates generally to an apparatus and method for configuring a transmission capability of a mobile communication system onto unused radio bands/channels.

### BACKGROUND

Prior art which may provide useful background information to this technical field can e.g. be found by the technical specification TS 36.331 (current version: 10.0.0) of the 3GPP.

The following meanings for the abbreviations used in this specification apply:

BW: Bandwidth

DL: Downlink

eNB: evolved Node B

FCC: Federal Communications Commission

L-GW: Local Gateway

LTE: Long Term Evolution

LTE-A: LTE-Advanced

MIB: Master Information Block

PBCH: Physical Broadcast Channel

PDCCH: Physical Downlink Control Channel

P-GW: Packet Data Network Gateway

PRB: Physical Resource Blocks

PUCCH: Physical Uplink Control Channel

RRC: Radio Resource Control

S-GW: Serving Gateway

SIB: System Information Block

TDD: Time Division Duplex

TV: Television

TVBD: TV Band Device

TVWS: TV White Space

UL: Uplink

In recent years, as on the field of mobile communications licensed band operation has been increasingly utilized, operators, service providers, communication device manufacturers, and communication system manufacturers, are all seeking efficient solutions to utilize unlicensed shared band operation.

For example, one possible spectrum opportunity would be the so-called TV white spaces (TVWS).

Specifically, governmental and/or administrative bodies assign different frequencies for specific applications, and usually license the rights to use these frequencies. This frequency allocation process creates a band plan, which assigns so-called white space, i.e. unused frequencies, between used radio bands or channels to avoid interferences. In some cases, although the frequencies are unused, they have been specifically assigned for a purpose, such as a guard band. In other cases however, these white spaces exist between used channels, since assigning nearby transmissions to immediately adjacent channels will cause destructive interference to both. In addition, there is also unused radio spectrum which has either never been used, or is becoming free as a result of technical changes.

For instance in television there is the example that the switchover to digital television frees up much frequency space.

Thus, the potential use of TV white spaces has been investigated widely in the recent years, due to their available large bandwidths at suitable frequencies for different radio applications. However, the TV spectrum administration is almost country dependent. Currently, the Federal Communications Commission (FCC) of the USA gives detailed description concerning the utilization of TV white spaces' regulations for US area.

At present, the FCC defines two concepts for the help of find available channels, namely a TV bands database and the geo-location capability. A TV band database that maintains records of all authorized services in the TV frequency bands is capable of determining the available channels as a specific geographic location and provides lists of available channels to any TVBD that has been certified under the FCC's equipment authorization procedures. The geo-location capability is defined for some of the TVBD. A TVBD with such capability should be able to determine its geographic coordinates within a certain level of accuracy (±50 m). This capability is used with a TV bands database to determine the availability of TV channels at the specific location of a TVBD.

### SUMMARY OF THE INVENTION

It is an object of the present invention to provide an apparatus and method for configuring a transmission capability of a mobile communication system onto unused radio bands/channels.

According to a first aspect of the present invention, this is accomplished by an apparatus, comprising a channel detection processor configured to determine channels of a television radio-band which are free of signal transmission and channels with active signal transmission, and to select a group of channels immediately adjacent in the frequency domain among the channels which are free of signal transmission, a downlink bandwidth allocation processor configured to allocate a downlink bandwidth to channels of the selected channel group which are not immediately adjacent in the frequency domain to a channel with active signal transmission, and an uplink bandwidth allocation processor configured to allocate an uplink bandwidth to all channels of the selected channel group.

Modifications of the first aspect may be as follows.

The apparatus according to the first aspect may be configured to be suitable for configuring a transmission capability of a mobile communication system onto unused radio bands/channels.

The downlink bandwidth allocation processor can be configured to allocate a common control in the middle of the channels to which downlink bandwidth is thus allocated, and the uplink bandwidth allocation processor can be further configured to allocate an uplink control to edges of the downlink bandwidth.

The apparatus can further comprise a transmission power control processor configured to control transmission power on channels of the selected channel group to which uplink bandwidth is allocated and which are immediately adjacent in the frequency domain to a channel with active signal transmission, wherein the control is according to a preset transmission power restriction for avoiding interference with the channel with active signal transmission.

The apparatus can further comprise a system information processor configured to provide information on a channel spectrum in terms of channels which are free of signal transmission and channels with active signal transmission.

The downlink bandwidth allocation processor can be further configured to allocate a downlink bandwidth according to a preset scheme according to which the downlink bandwidth is allocated to channels of the selected channel group which are not immediately adjacent in the frequency domain to a channel with active signal transmission.

The apparatus can further comprise a plurality of processors constituting an evolved Node B functionality.

The apparatus can further comprise a plurality of processors constituting a modem functionality.

The channel detection processor, the downlink bandwidth allocation processor, and the uplink bandwidth allocation processor can be implemented as a chipset.

The channel detection processor, the downlink bandwidth allocation processor, the uplink bandwidth allocation processor, and the system information processor can be implemented as a chipset.

According to a second aspect of the present invention, the object is accomplished by an apparatus, comprising channel detection means for determining channels of a television radio-band which are free of signal transmission and channels with active signal transmission, and for selecting a group of channels immediately adjacent in the frequency domain among the channels which are free of signal transmission, downlink bandwidth allocation means for allocating a downlink bandwidth to channels of the selected channel group which are not immediately adjacent in the frequency domain to a channel with active signal transmission, and uplink bandwidth allocation means for allocating an uplink bandwidth to all channels of the selected channel group.

Modifications of the second aspect of the present invention may correspond to the modifications of the first aspect.

According to a third aspect of the present invention, the object is accomplished by a method, comprising determining channels of a television radio-band which are free of signal transmission and channels with active signal transmission, selecting a group of channels immediately adjacent in the frequency domain among the channels which are free of signal transmission, allocating a downlink bandwidth to channels of the selected channel group which are not immediately adjacent in the frequency domain to a channel with active signal transmission, and allocating an uplink bandwidth to all channels of the selected channel group.

Modifications of the third aspect may be as follows.

The method according to the third aspect may be configured to be suitable for configuring a transmission capability of a mobile communication system onto unused radio bands/channels.

Allocating a downlink bandwidth can further comprise allocating a common control in the middle of the channels to which downlink bandwidth is thus allocated, and allocating an uplink bandwidth can further comprise allocating an uplink control to edges of the downlink bandwidth.

The method can further comprise controlling transmission power on channels of the selected channel group to which uplink bandwidth is allocated and which are immediately adjacent in the frequency domain to a channel with active signal transmission, wherein the controlling is performed according to a preset transmission power restriction for avoiding interference with the channel with active signal transmission.

The method can further comprise providing information on a channel spectrum in terms of channels which are free of signal transmission and channels with active signal transmission.

Allocating a downlink bandwidth can further comprise allocating a downlink bandwidth according to a preset scheme according to which the downlink bandwidth is allocated to channels of the selected channel group which are not immediately adjacent in the frequency domain to a channel with active signal transmission.

The method according to the third aspect or any of its modifications may be performed by the apparatus according to the first or second aspect or suitable ones of their modifications.

According to a fourth aspect of the present invention, the object is accomplished by a computer program product comprising computer-executable components which perform, when the program is run on a computer determining channels of a television radio-band which are free of signal transmission and channels with active signal transmission, selecting a group of channels immediately adjacent in the frequency domain among the channels which are free of signal transmission, allocating a downlink bandwidth to channels of the selected channel group which are not immediately adjacent in the frequency domain to a channel with active signal transmission, and allocating an uplink bandwidth to all channels of the selected channel group.

Modifications of the fourth aspect may be as follows.

The computer program product according to the fourth aspect may be suitable for configuring a transmission capability of a mobile communication system onto unused radio bands/channels.

The computer program product according to the fourth aspect may be embodied as a computer-readable storage medium.

Otherwise, modifications of the fourth aspect may correspond to the modifications of the third aspect.

It is to be understood that any of the above modifications can be applied singly or in combination to the respective aspects to which they refer, unless they are explicitly stated as excluding alternatives.

### BRIEF DESCRIPTION OF THE DRAWINGS

The above and other objects, features, details and advantages will become more fully apparent from the following detailed description of example embodiments which is to be taken in conjunction with the appended drawings, in which:

FIG. 1 shows an apparatus according to certain embodiments of the present invention;

FIG. 2 shows a flow chart showing operations for performing a method according to certain embodiments of the present invention;

FIG. 3 shows an example situation for a white space spectrum on a TV frequency band to which certain embodiments of the present invention may be applied;

FIG. 4 shows a possible LTE TDD system deployment according to certain embodiments of the present invention;

FIG. 5 shows various configuration cases according to certain embodiments of the present invention;

FIG. 6 shows examples for an implicit downlink and uplink bandwidth configuration according to certain embodiments of the present invention;

FIG. 7 shows an exemplary illustration of high level actions to be performed by a device implementation example according to certain embodiments of the present invention; and

FIG. 8 shows an exemplary illustration of high level operation of a device implementation example according to certain embodiments of the present invention.

### DETAILED DESCRIPTION OF THE EXAMPLE EMBODIMENTS

In the following, description is made to what are presently considered to be suitable embodiments of the present invention. It is to be understood, however, that the description is given by way of example only, and that the described embodiments are by no means to be understood as limiting the present invention thereto.

For example, for illustration purposes, in some of the following exemplary embodiments, configuring a transmission capability of a mobile communication system onto unused radio bands/channels as e.g. based on LTE or LTE-Advanced is described. However, it should be appreciated that these exemplary embodiments are not limited for use among these particular types of wireless communication systems, and according to further exemplary embodiments, the present invention can be applied also to other types of communication systems and access networks.

Thus, certain embodiments of the present invention relate to mobile wireless communication systems, such as 3GPP LTE and 3GPP LTE-Advanced. In more detail, certain embodiments of the present invention are related to the configuration of an LTE eNB and components thereof, or the like.

However, as indicated above, the present invention is not limited to eNB, and other embodiments of the present invention are for example related to mobile terminals and components thereof.

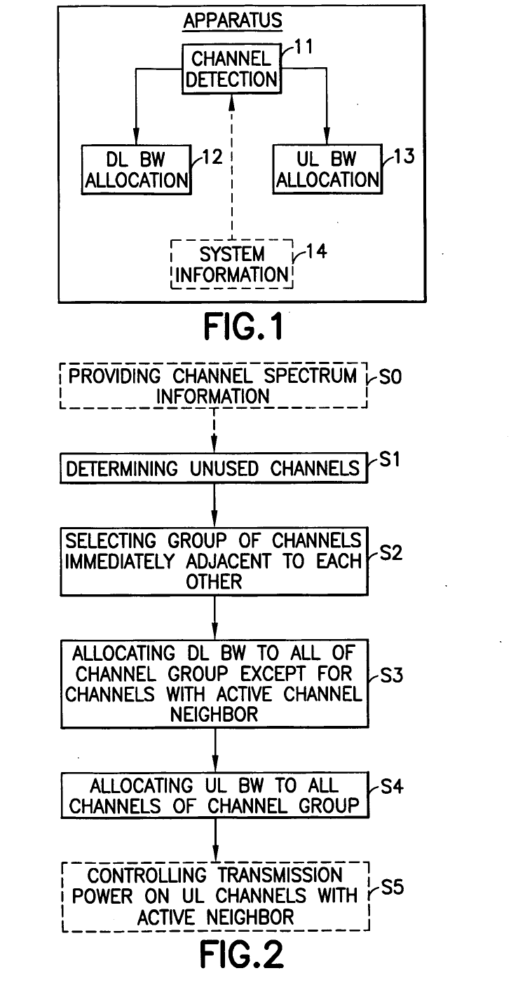

FIG. 1 shows a principle configuration of an example for an apparatus according to certain embodiments of the present invention. One option for implementing this example for an apparatus according to certain embodiments of the present invention would be a component in an eNB according to LTE.

Specifically, as shown in FIG. 1, the example for an apparatus comprises a channel detection processor 11 configured to determine channels of a television radio-band which are free of signal transmission and channels with active signal transmission, and to select a group of channels immediately adjacent in the frequency domain among the channels which are free of signal transmission, a downlink bandwidth allocation processor 12 configured to allocate a downlink bandwidth to channels of the selected channel group which are not immediately adjacent in the frequency domain to a channel with active signal transmission, and an uplink bandwidth allocation processor 13 configured to allocate an uplink bandwidth to all channels of the selected channel group.

FIG. 1 also indicates plural possible modifications according to certain embodiments of the present invention by additionally showing the optional provision of a system information processor 14 comprised in the apparatus which is configured to provide information on a channel spectrum in terms of channels which are free of signal transmission and channels with active signal transmission.

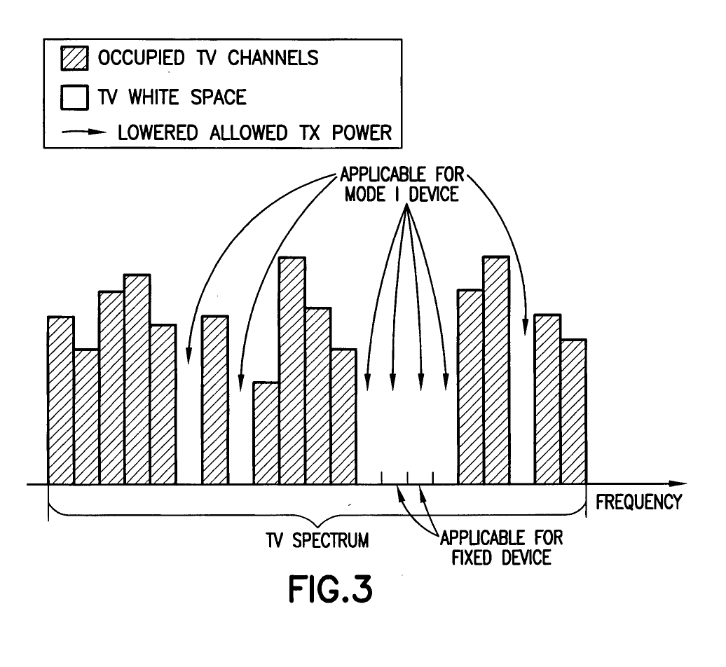

FIG. 2 shows a principle flowchart of an example for a method according to certain embodiments of the present invention. That is, as shown in FIG. 2, this method comprises determining (step S1) channels of a television radio-band which are free of signal transmission and channels with active signal transmission, selecting (step S2) a group of channels immediately adjacent in the frequency domain among the channels which are free of signal transmission, allocating (step S3) a downlink bandwidth to channels of the selected channel group which are not immediately adjacent in the frequency domain to a channel with active signal transmission, and allocating (step S4) an uplink bandwidth to all channels of the selected channel group.

FIG. 2 also indicates plural possible modifications according to certain embodiments of the present invention by additionally showing the optional provision of providing (step SO) information on a channel spectrum in terms of channels which are free of signal transmission and channels with active signal transmission and/or controlling (step S5) transmission power on channels of the selected channel group to which uplink bandwidth is allocated and which are immediately adjacent in the frequency domain to a channel with active signal transmission, wherein the controlling is performed according to a preset transmission power restriction for avoiding interference with the channel with active signal transmission.

An option for performing the example(s) of a method according to certain embodiments of the present invention would be to use the apparatus as described above or a modification thereof which becomes apparent from the embodiments as described herein below.

Certain embodiments of the present invention are described herein below in further detail. It is to be noted though, that the features of the embodiments may be interchanged and mixed as will be understood from the whole of the present specification.

Specifically, certain embodiments of the present invention relate to TVBD and components thereof. Accordingly, in the following description is provided by referring to the example of TV white space. Though, as already indicated above, it is to be understood that the present invention is not limited to use on TV white space.

In detail, several types of TVBDs have been defined by FCC based on their characteristics, which are

a) Fixed device: A fixed TVBD is located at a specified fixed location. It has the functions to be able to select a channel from the TV bands database, to be able to initiate and operate a network (by sending enabling signals to other fixed TVBDs or personal/portable TVBDs), and to be able to provide to a Mode I personal/portable device a list of available channels on which the Mode I device may operate (about TV channel 20), especially a supplemental list of available channels for Mode I devices (available channels that are adjacent to occupied TV channels, for which fixed TVBD cannot operate). For example, an eNB (+MME, L-GW/S-GW+P-GW) could be considered as a fixed device.

b) Mode I personal/portable device: Such a device does not use an internal geo-location capability and access to a TV bands database, so it must obtain a channel list from either a fixed TVBD or Mode II personal/portable TVBD. This kind of device may work only as a client/slave, but not as a master.

c) Mode II personal/portable device: A Mode II personal/portable device has similar functions as a fixed TVBD, but does not need to transmit/receive signals at a specified and fixed place.

d) Sensing only device: A personal/portable TVBD that uses spectrum sensing to determine a list of available channels. It can use the frequency bands 512-608 MHz (TV channels 21-36) and 614-698 MHz (TV channels 38-51). It is to be noted that spectrum sensing is only defined for personal/portable TVBDs.

The transmission power limits are as follows. For fixed TVBDs, the maximum power delivered to the TX antenna shall not exceed 1W. For personal/portable TVBDs, the maximum effective isotropic radiated power (EIRP) is 100 mW (20 dBm). If the personal/portable TVBD does not meet the adjacent channel separation requirements, i.e. the distance between the TVBD and the TV station is smaller than the minimum distance requirement, the maximum EIRP is set to 40 mW (16 dBm).

The maximum power spectral densities (any 100 kHz during any time interval of continuous transmission) for different types of TVBDs are for:
Fixed devices: 12.2 dBm
Personal/portable devices operating adjacent to occupied

TV channels: −1.6 dBm
Sensing only devices: −0.8 dBm
All other personal/portable devices: 2.2 dBm

Furthermore, fixed TVBDs, i.e. for example eNBs, are not allowed to use the adjacent channel of the active TV channel.

An exemplary illustration of the possible TV WS setup is given in FIG. 3 showing an explanatory situation for white space spectrum on TV frequency band.

According to certain embodiments of the present invention, it is proposed to configure a novel advanced LTE TDD system in standalone manner onto such TV WS.

With certain embodiments of the present invention it is possible to effectively configure downlink and uplink operating bandwidth by the LTE TDD system when operating on TV WS.

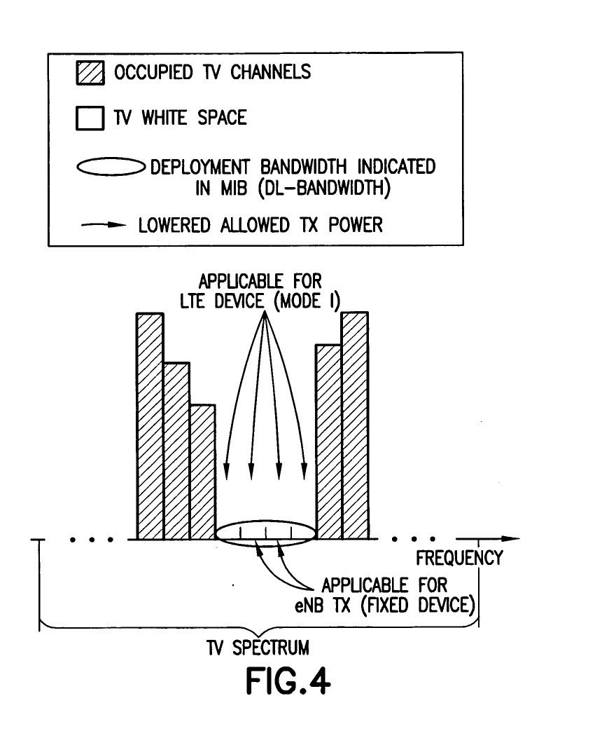

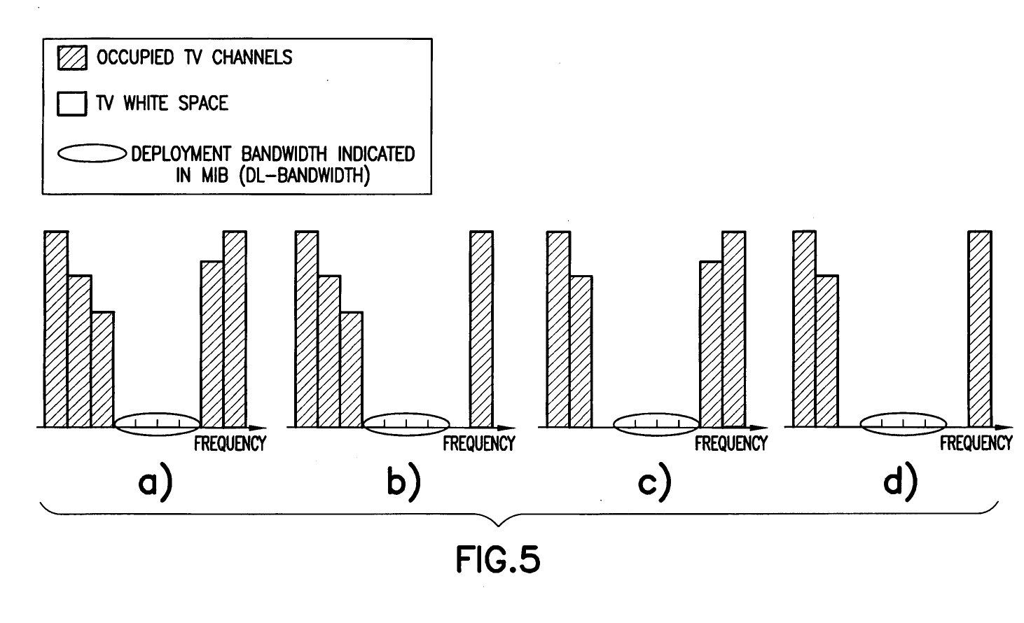

Specifically, referring to FIG. 4 showing a possible LTE TDD system deployment, when deploying e.g. four adjacent free TV channels (circulated in FIG. 4), the LTE system would be able to center those to be used for the downlink and use all four channels for the uplink transmission. As indicated above, devices transmitting in uplink on outer edge channels have certain transmission power restrictions compared to other channels in use, i.e. when neighbored to occupied channels.

Moreover, according to certain embodiments of the present invention the LTE system deploying the TV WS could include in the system information (e.g. the Radio Resource Control (RRC)) knowledge whether deployed bandwidth on TV WS (circulated in FIG. 4) is in actual use cases as illustrated in FIG. 5 flanked by active TV channels on both sides of the bandwidth (see case a) in FIG. 5), is flanked by an active TV channel on the “left side” of the bandwidth (see case b) in FIG. 5), is flanked by an active TV channel on the “right side” of the bandwidth (see case c) in FIG. 5), or is flanked by free TV channels on both sides (See case d) in FIG. 5).

As a general remark, it is to be noted that although many of the described embodiments refer to an explanatory case of four channels for use in the deployment bandwidth, certain embodiments of the present invention can include cases where e.g. the deployment bandwidth is constituted by three channels having the DL channel in the middle or with two channels out of three (or more) free channels having the DL channel adjacent to a non-active channel, or with any number of channels under the condition that it is possible to have the DL channel(s) adjacent to a non-active TV channel in case of a fixed device such as the eNB/base station.

Furthermore, certain embodiments of the present invention consider that in LTE system, deployment bandwidth is defined and indicated in Master Information Block (MIB) which is carried on the Physical Broadcast Channel (PBCH). In LTE TDD system, a MIB parameter dl-Bandwidth defines both downlink and uplink effective bandwidth.

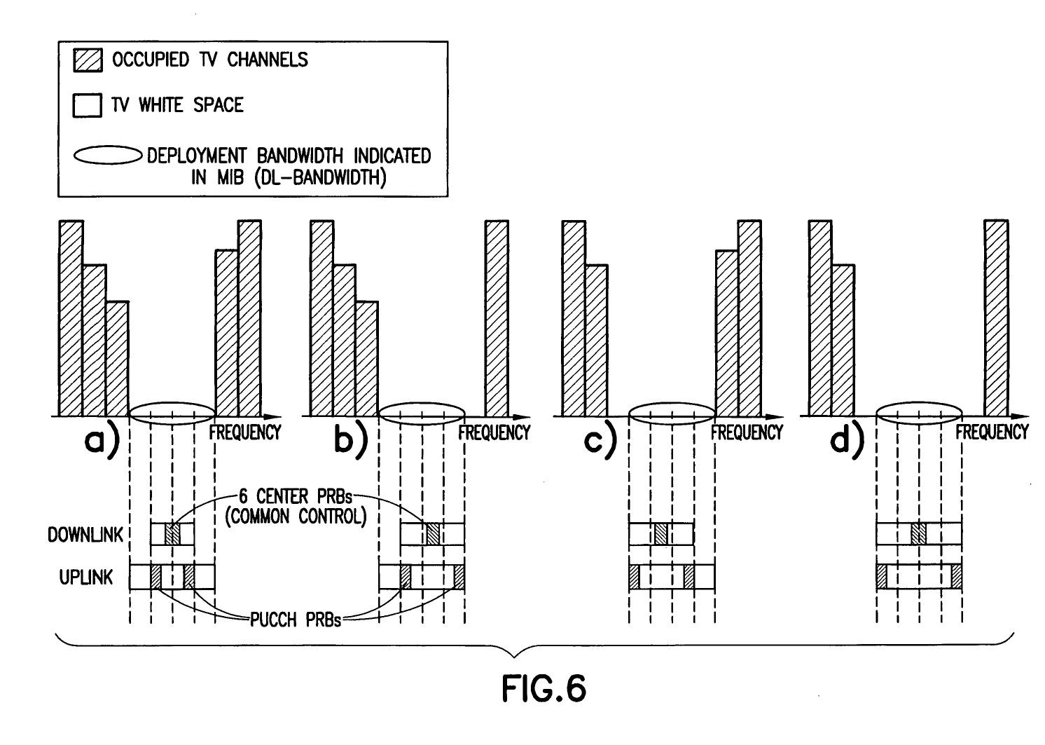

Thus, according to such further certain embodiments of the present invention the provided configuration together with deployment bandwidth given in MIB (dl-Bandwidth) is used to derive effective downlink and uplink bandwidth as follows and as illustrated in FIG. 6 (implicit mapping) reprising the principle cases of FIG. 5:
In a) the downlink bandwidth is deployed onto mid available TV channels and uplink bandwidth is deployed on all available TV channels. Furthermore, in uplink the PUCCH PRBs are allocated corresponding to the edges of the downlink effective bandwidth, not corresponding to the uplink effective bandwidth due to possible limited coverage on channels adjacent to active TV channels (see case a) in FIG. 6).
In b) the downlink bandwidth is deployed over all the TV channels under deployment bandwidth except the most left side TV channel which is adjacent to an active TV channel. PUCCH PRBs are again mapped according to downlink effective bandwidth within the deployment bandwidth, not according to the uplink effective bandwidth which is greater than the downlink one (see case b) in FIG. 6).
In c) the derivation of effective downlink and uplink bandwidths is similar to case b), but just vice versa regarding the “left side” and the “right side”.
In d) the derivation leads to conventional downlink and uplink bandwidth mapping (see case d) in FIG. 6).

Furthermore, the device is able to derive implicitly from the above information the reduced transmission power for the uplink resources that are adjacent to active TV channel.

According to certain embodiments of the present invention an alternative could be to form a backward compatible solution which is to inform the downlink effective bandwidth as conventionally, i.e. directly by the dl-Bandwidth in MIB, but the uplink effective bandwidth is derived from the additional information if the eNB has enabled larger uplink bandwidth than downlink bandwidth. By allocating PUCCH always according to the downlink effective capacity, as described above in connection with FIG. 6, keeps also uplink allocation backward compatible for older release LTE devices. Other devices fully supporting one of the aforementioned methods could then use additional uplink resources beyond resources corresponding to downlink resources by reading additional/new bit fields e.g. in MIB (for older release devices, new fields are considered as spare bits, alternatively it can be informed in SIB1 or in other system information elements). A 2-bit field could be enough to indicate whether uplink is allocated one TV channel on both sides of the used TV channels by downlink definition, one TV channel on right or left side of the used TV channels by downlink definition, or no additional resources beyond downlink definition.

Also according to these embodiments, the device is able to derive implicitly from above information the reduced transmission power for the uplink resources that are adjacent to active TV channel.

In still further embodiments the LTE system could enable and disable the method described above to have wider uplink than downlink resources in TDD system.

According to further embodiments of the present invention, the knowledge about selected deployment bandwidth and adjacent active TV channels in MIB (see cases of FIG. 5) can be implemented with a 2-bit field and a feature enabler with a 1-bit field as described in the following based on the RRC specification (TS 36.331):

MasterInformationBlock

| | |
|---|---|
| -- ASN1START | |
| MasterInformationBlock ::= | SEQUENCE { |

| | |
|---|---|
| dl-Bandwidth | ENUMERATED { |
| | n6, n15, n25, n50, n75, n100}, |
| phich-Config | PHICH-Config, |
| systemFrameNumber | BIT STRING (SIZE (8)), |
| ulWiderThanDl | BIT STRING (SIZE (1)), |
| | (enabled/disabled) |
| activeAdjTVChannel | BIT STRING (SIZE (2)), |

| | |
|---|---|
| spare | BIT STRING (SIZE (7)) |

}
-- ASN1STOP

Alternatively, the proposed bit-fields could be transmitted e.g. in system information e.g. in SIB2.

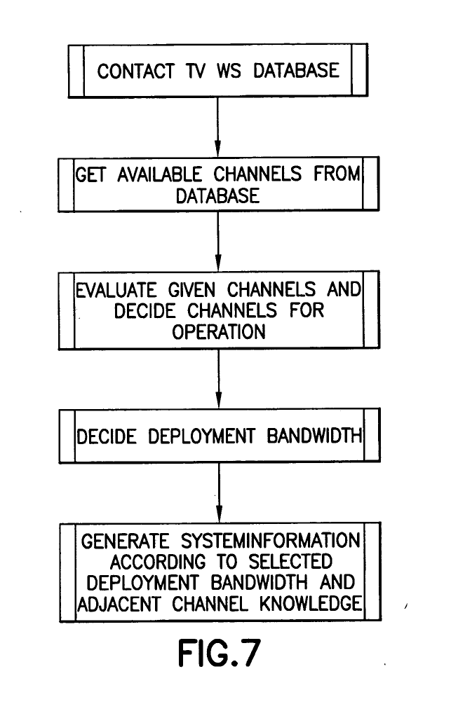

An exemplary flow chart for certain embodiments of the eNB of the LTE system is shown in FIG. 7 showing an exemplary illustration of high level actions by the eNB.

Specifically, related components of the eNB could first contact the TC WS database, and then get the available channels from the database. Thereafter, the available channels are evaluated and the channels for operation are decided upon. Further, the deployment bandwidth is to be decided upon. Finally, the system information according to the selected deployment bandwidth and knowledge about adjacent channels is generated.

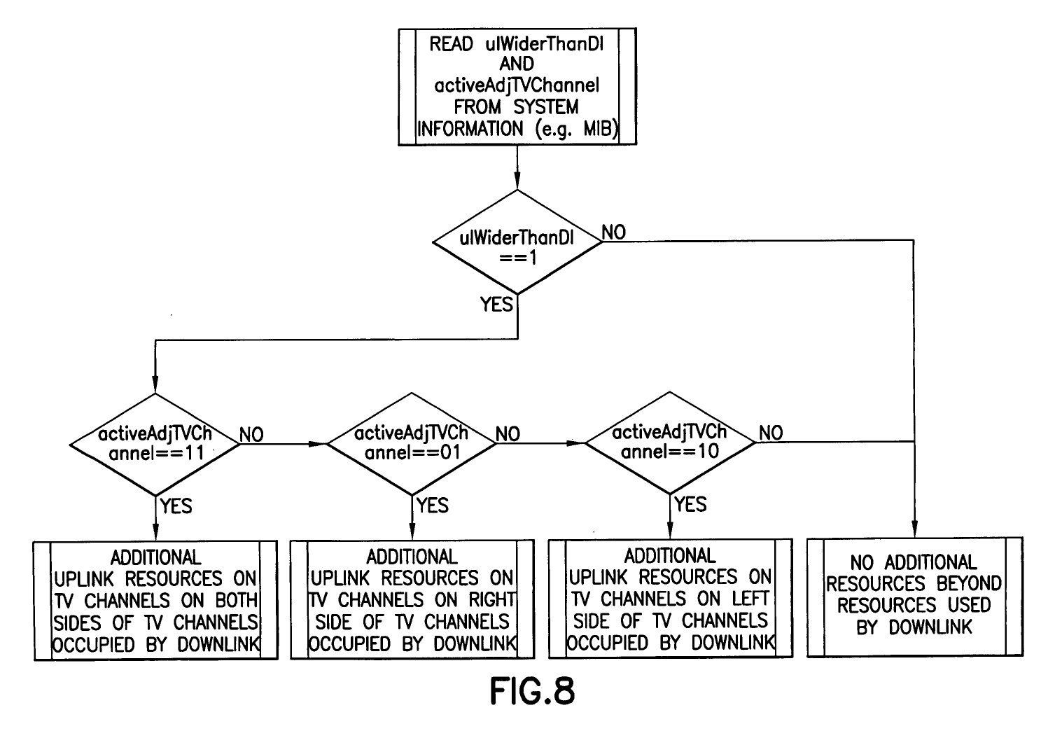

FIG. 8 shows an exemplary high level flow chart for a device connected to the eNB of the device side operations while reading/detecting such system information in the initial phase.

Specifically, the device initially reads whether the UL BW is wider than DL BW and the information about adjacent active channels. In case the UL BW is not wider than the DL BW, there are no additional resources in UL beyond the resources used in DL. On the other hand, in case the UL BW is in fact wider than the DL BW, the information on adjacent active channels is evaluated based on a two-bit field, wherein 11 indicates active channels on both sides informing that additional UL resources are on both sides of the channels occupied by the DL channels, 01 indicates additional UL resources on the right side of the channels occupied by the DL channels, and 10 indicates additional UL resources on the left side of the channels occupied by the DL channels.

As described above, certain embodiments of the present invention provide effective methods for an LTE TDD system to be deployed onto TV WS, so that novel LTE devices and networks utilizing TV WS (and other unlicensed spectrum) can make effective use thereof.

As indicated above, implementation examples for certain embodiments of the present invention include eNB equipment such as according LTE/LTE-Advanced, but are not limited thereto, and further include e.g. modems and other communication devices.

According to the above description, it should thus be apparent that exemplary embodiments of the present invention provide, for example from the perspective of a network element such as an eNB or a component thereof, an apparatus embodying the same, a method for controlling and/or operating the same, and computer program(s) controlling and/or operating the same as well as mediums carrying such computer program(s) and forming computer program product(s).

For example, described above are apparatuses, methods and computer program products capable of configuring a transmission capability of a mobile communication system onto unused radio bands/channels. Specifically, for example an apparatus, method and computer program product determine channels of a television radio-band which are free of signal transmission and channels with active signal transmission, select a group of channels immediately adjacent in the frequency domain among the channels which are free of signal transmission, allocate a downlink bandwidth to channels of the selected channel group which are not immediately adjacent in the frequency domain to a channel with active signal transmission, and allocate an uplink bandwidth to all channels of the selected channel group.

Implementations of any of the above described blocks, apparatuses, systems, techniques or methods include, as non limiting examples, implementations as hardware, software, for example in connection with a digital signal processor, an instruction set, firmware, special purpose circuits or application logic, general purpose hardware or controller or other computing devices, or some combination thereof. Software or application logic or an instruction set may be maintained on any one of various conventionally available computer-readable media (which shall be understood as anything which can contain, store, communicate, propagate or transport instructions in connection with an instruction execution system). Further, it is to be understood that where reference is made to a processor, such processor is to be understood in its broadest sense and may, for example, additionally comprise or not comprise a memory (e.g., ROM, CD-ROM, etc.), and it may comprise a computer processor, an application-specific integrated circuit (ASIC), a field-programmable gate array (FPGA), and/or other hardware components that have been programmed in such a way to carry out the described function.

If desired, the different functions discussed herein may be performed in a different order and/or concurrently with each other. Furthermore, if desired, one or more of the above-described functions may be optional or may be combined.

Although various aspects of the invention are set out in the appended independent claims, other aspects of the invention comprise other combinations of features from the described embodiments and/or the dependent claims with the features of the independent claims, and not solely the combinations explicitly set out in the claims.

What is described above is what is presently considered to be preferred embodiments of the present invention. However, as is apparent to the skilled reader, these are provided for illustrative purposes only and are in no way intended that the present invention is restricted thereto. Rather, it is,the intention that all variations and modifications be included which fall within the spirit and scope of the appended claims.

1. An apparatus, comprising
a channel detection processor configured to determine channels of a television radio-band which are free of signal transmission and channels with active signal transmission, and to select a group of channels immediately adjacent in the frequency domain among the channels which are free of signal transmission,
a downlink bandwidth allocation processor configured to allocate a downlink bandwidth to channels of the selected channel group which are not immediately adjacent in the frequency domain to a channel with active signal transmission, and
an uplink bandwidth allocation processor configured to allocate an uplink bandwidth to all channels of the selected channel group.

2. The apparatus according to claim 1, wherein
the downlink bandwidth allocation processor is further configured to allocate a common control in the middle of the channels to which downlink bandwidth is thus allocated, and
the uplink bandwidth allocation processor is further configured to allocate an uplink control to edges of the downlink bandwidth.

3. The apparatus according to claim 1, further comprising
a transmission power control processor configured to control transmission power on channels of the selected channel group to which uplink bandwidth is allocated and which are immediately adjacent in the frequency domain to a channel with active signal transmission, wherein the control is according to a preset transmission power restriction for avoiding interference with the channel with active signal transmission.

4. The apparatus according to claim 1, further comprising
a system information processor configured to provide information on a channel spectrum in terms of channels which are free of signal transmission and channels with active signal transmission.

5. The apparatus according to claim 1, wherein the downlink bandwidth allocation processor is further configured to allocate a downlink bandwidth according to a preset scheme according to which the downlink bandwidth is allocated to channels of the selected channel group which are not immediately adjacent in the frequency domain to a channel with active signal transmission.

6. The apparatus according to claim 1, further comprising a plurality of processors constituting an evolved Node B functionality.

7. The apparatus according to claim 1, further comprising a plurality of processors constituting a modem functionality.

8. The apparatus according to claim 1, wherein the channel detection processor, the downlink bandwidth allocation processor, and the uplink bandwidth allocation processor are implemented as a chipset.

9. The apparatus according to claim 4, further comprising a plurality of processors constituting an evolved Node B functionality.

10. The apparatus according to claim 4, further comprising a plurality of processors constituting a modem functionality.

11. The apparatus according to claim 4, wherein the channel detection processor, the downlink bandwidth allocation processor, the uplink bandwidth allocation processor, and the system information processor are implemented as a chipset.

12. A method, comprising
determining channels of a television radio-band which are free of signal transmission and channels with active signal transmission,
selecting a group of channels immediately adjacent in the frequency domain among the channels which are free of signal transmission,
allocating a downlink bandwidth to channels of the selected channel group which are not immediately adjacent in the frequency domain to a channel with active signal transmission, and
allocating an uplink bandwidth to all channels of the selected channel group.

13. The method according to claim 12, wherein
allocating a downlink bandwidth further comprises allocating a common control in the middle of the channels to which downlink bandwidth is thus allocated, and
allocating an uplink bandwidth further comprises allocating an uplink control to edges of the downlink bandwidth.

14. The method according to claim 12, further comprising
controlling transmission power on channels of the selected channel group to which uplink bandwidth is allocated and which are immediately adjacent in the frequency domain to a channel with active signal transmission, wherein the controlling is performed according to a preset transmission power restriction for avoiding interference with the channel with active signal transmission.

15. The method according to claim 12, further comprising
providing information on a channel spectrum in terms of channels which are free of signal transmission and channels with active signal transmission.

16. The method according to claim 12, wherein allocating a downlink bandwidth further comprises allocating a downlink bandwidth according to a preset scheme according to which the downlink bandwidth is allocated to channels of the selected channel group which are not immediately adjacent in the frequency domain to a channel with active signal transmission.

17. A computer program product comprising computer-executable components which perform, when the program is run on a computer:
determining channels of a television radio-band which are free of signal transmission and channels with active signal transmission,
selecting a group of channels immediately adjacent in the frequency domain among the channels which are free of signal transmission,
allocating a downlink bandwidth to channels of the selected channel group which are not immediately adjacent in the frequency domain to a channel with active signal transmission, and
allocating an uplink bandwidth to all channels of the selected channel group.

18. The computer program product according to claim 17, embodied as a computer-readable storage medium.
